(19) United States
(12) Patent Application Publication
(10) Pub. No.: US 2013/0104694 A1
(43) Pub. Date: May 2, 2013

(54) Bicycle pedal

(71) Applicant: Xiao-Ming Deng, Flushing, NY (US)

(72) Inventor: Xiao-Ming Deng, Flushing, NY (US)

(21) Appl. No.: 13/284,906

(22) Filed: Oct. 30, 2011

(51) Int. Cl. B62M 3/08

(52) U.S. Cl. 74/594.6

(57) ABSTRACT

A bicycle pedal, comprising a pedal body; a shaft having a first end and a second end, said first end rotatably coupled to a middle portion of said pedal body, said second end at inner side adapted to be coupled to a bicycle crank arm; a L-shaped device, comprising a shorter portion, a bend, and a longer portion, said longer portion lengthwise slidably connect to an inner side portion of said pedal body, cross widthwise of said pedal body, while said shorter portion at rear extending form inner side toward an direction opposite to inner side; and an elastic means having a first end connect to a middle portion of said L-shaped device, and a second end connect to a portion of said pedal body.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention relates to a bicycle pedal having a lengthwise auto-retractable L-shaped device, allow the back of a foot to pull a pedal.

2. Prior Art

Most push and pull bicycle pedals today are either allow user to pull using the sole of a special shoe or pull using upper part of a foot. However, bicycle pedal allow the back of a foot to pull is virtually nonexistence.

Pedal attachment in U.S. Pat. No. 3,960,027 by Magnuson allows user to pull the pedal using the back of a foot or heel, but the pedal attachment will scratch the ground when biker walk with the bicycle. Moreover, the pedal attachment from Magnuson is too big, cumbersome, and awkward. The same problems exist in the bicycle pedal described in U.S. Pat. No. 5,662,006 by Angeltun. Furthermore, the pedal from Angeltun requires biker to wear special shoe to engage the pedal at the heel. That makes it very user unfriendly.

### OBJECTS AND ADVANTAGES

This invention introduces a new push and pull bicycle pedal having an auto-retractable sliding L-shaped device, allow user to pull the pedal using the back of a foot. The bicycle pedal of this invention having the following objects and advantages:
1) biker can operate the pedal simply wearing sneaker;
2) both side of the pedal can be used as an ordinary sole pushing pedal, and one side of the pedal allow user to pull using the back of a foot;
3) easy to engage, user simply step on the pedal and slide their foot backward;
4) more comfortable to operate compare to other forms of push and pull bicycle pedals, because the heel is the toughest and strongest part of a foot;
5) very easy to disengage, user simply move their foot outward, upward, and/or forward, then the L-shaped device will automatically retract to the pedal body; and
6) user can walk with bicycle without having the pedal scratching ground.

### SUMMARY

A bicycle pedal having a retractable heel coupling device made from a bent L-shaped sheet metal (7a, 7b, 7c) slidably connect to a pedal tail 6c fixed to an inner side corner of the pedal body. The L-shaped sheet metal (7a, 7b, 7c) having a shorter portion 7a, a bend 7b, a longer portion 7c, and a groove 7d. The pedal tail 6c having a first hole 6e and a second hole 6d; wherein the first hole is higher than the second hole and farther away from the pedal body. The mid-points from each of the two holes define a line having an acute angle to widthwise of the pedal body and parallel to a plane sufficiently perpendicular to pedal shaft 4.

L-shaped sheet metal (7a, 7b, 7c) connect to pedal tail 6c by having bolts 73a, 71a respectively enter groove 7d then holes 6e, 6d and secured by washers and hex nuts on the other side. Elastic means such as spring 8 or rubber band 8b or 8b having one end connect to a middle portion of L-shaped sheet metal (7a, 7b, 7c) at position 7e and another end connect to pedal tail 6c at position 6d.

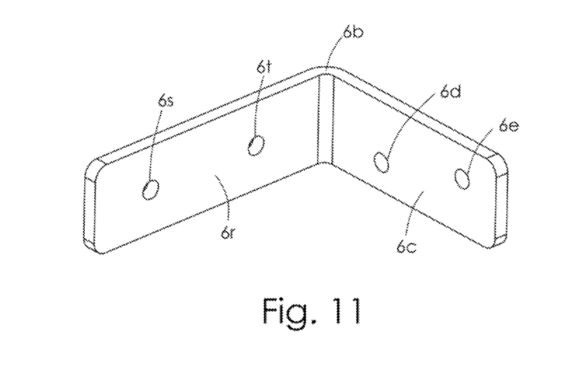

The pedal tail 6c does not have to be a continuation from a part of a pedal body. The pedal tail could be a separate piece of a sheet metal. FIG. 11 provides an example. Holes 6s, 6t on member 6r will allow attachment to a rear portion of a pedal body, and holes 6d, 6e on member 6c will allow L-shaped sheet metal (7a, 7b, 7c) attachment.

### DRAWING

### Figures

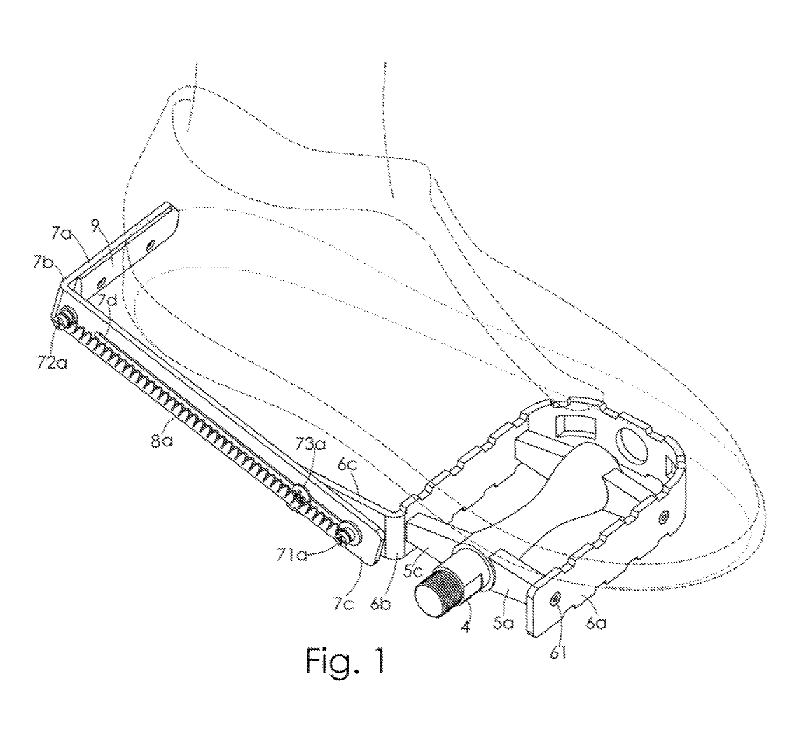

FIG. 1 is a perspective view on my invention engaged by a foot.

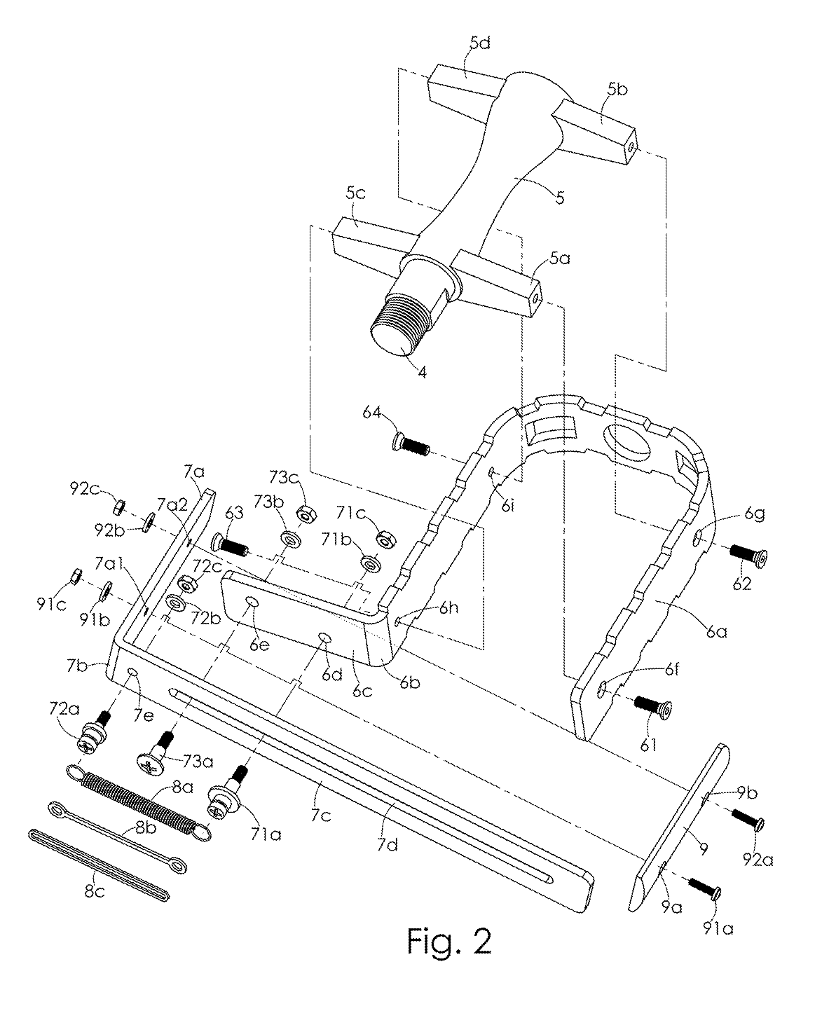

FIG. 2 is an exploded view of my invention.

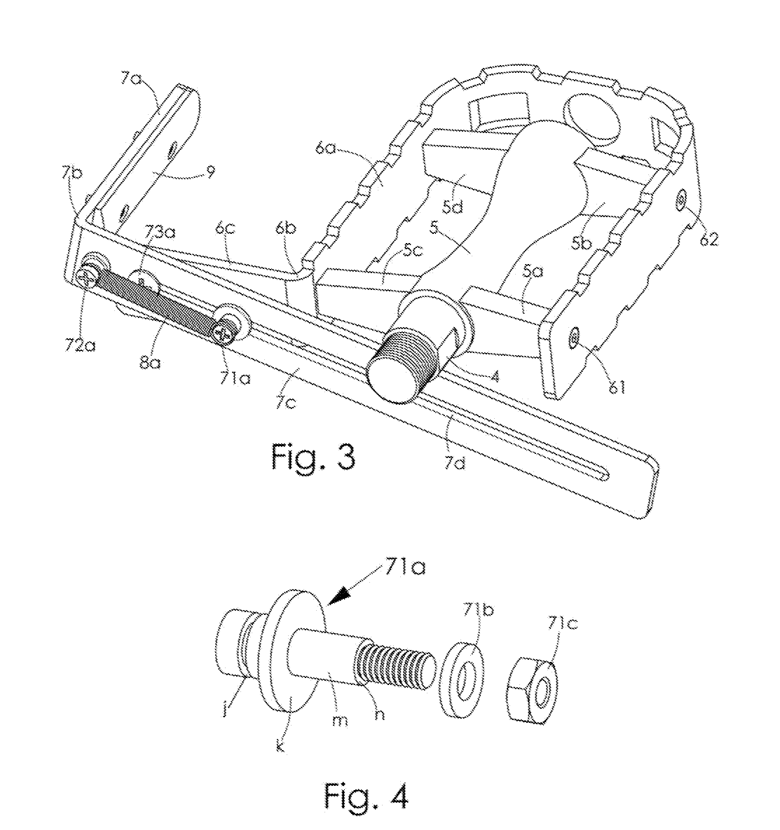

FIG. 3 is a perspective view of my invention from inner side.

FIG. 4 is an exploded view on bolt, washer, and nut.

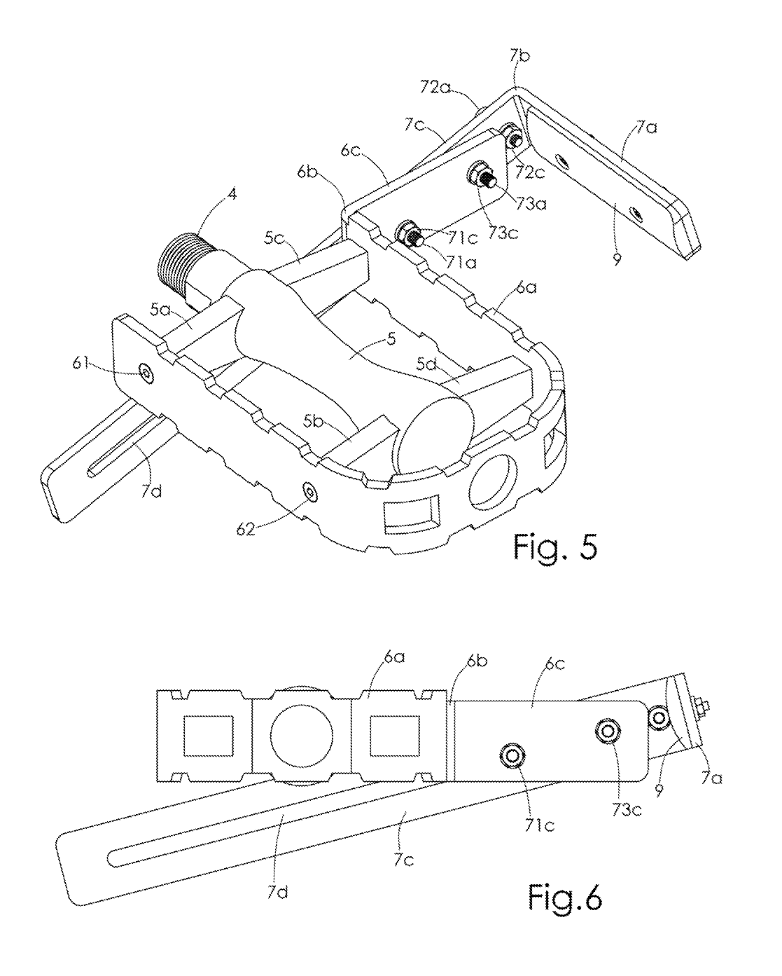

FIG. 5 is a perspective view of my invention from outer side.

FIG. 6 is an outer side view of my invention.

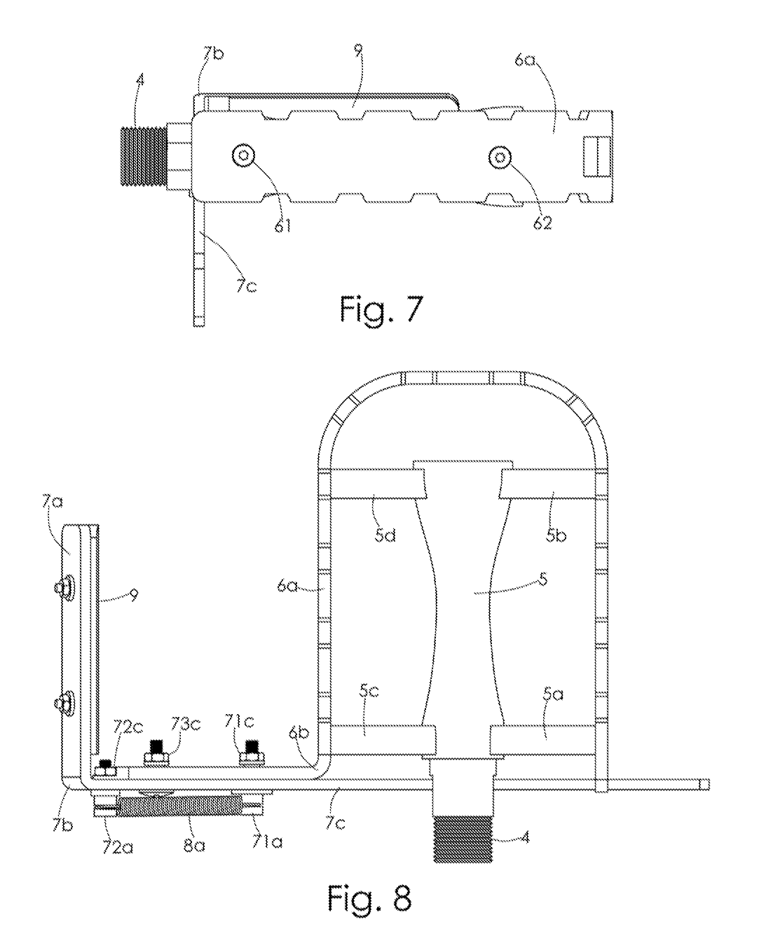

FIG. 7 is a front view of my invention.

FIG. 8 is a top view of my invention.

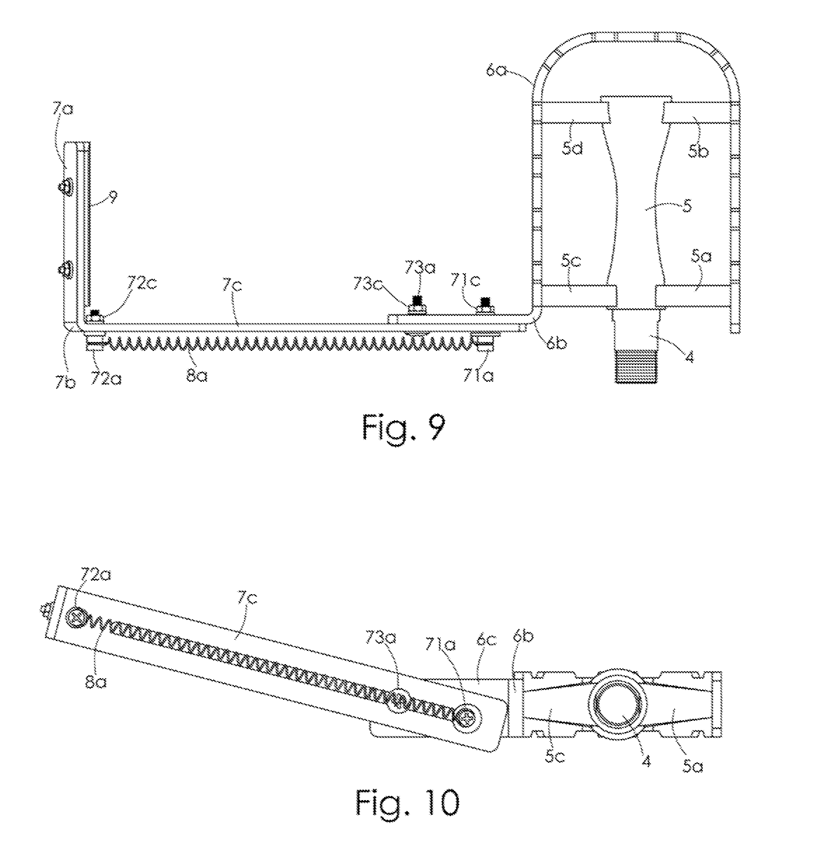

FIG. 9 is a top view of my invention.

FIG. 10 is an inner side view of my invention.

FIG. 11 is a perspective view on a pedal tail attachment.

### REFERENCE NUMERALS

4 pedal shaft
5 pedal stem
5a, 5b, 5c, 5d pedal branches
6a U shaped pedal cage
6b right angle bend
6c pedal tail
6d, 6e, 6f, 6g, 6h, 6i holes
61, 62, 63, 64 screws
(6r, 6b, 6c) pedal tail attachment
(7a, 7b, 7c) bent L-shaped sheet metal (or L-shaped heel coupler)
7a shorter portion
7a1, 7a2 holes
7b bend
7c longer portion
7d groove
7e hole
71a bolt, or spring connector, or connectable means
72a bolt, or spring connector, or connectable means
73 bolt
71b, 72b, 73b washers
71c, 72c, 73c hex nuts
8a spring
8b rubber band
8c rubber band
9 cushion
9a, 9b holes
91a, 91a screws
92b, 92b washers
93c, 93c hex nuts
j groove
k stopper
m shaft
n stopper

### DETAILED DESCRIPTION

### FIGS. 1, 2, 3, 4, 5, 6, 7, 8, 9, 10, 11—Preferred Embodiment

Referring to FIG. 2, this invention focuses on two components, pedal tail 6c and L-shaped sheet metal (7a, 7b, 7c). The L-shaped sheet metal having a shorter portion 7a, a bend 7b, a longer portion 7c, and a groove 7d to allow slidable connection to pedal tail 6c. The bent L-shaped sheet metal (7a, 7b, 7c) connect to pedal tail 6c by superimpose longer portion 7c at inner side of pedal tail 6c, then passing bolts 71a, 73a from inner side through groove 7d then holes 6d, 6e on pedal tail 6c, and then secure by washers 71b, 73b and hex nuts 71c, 73c on the opposite side. Another bolt 72a insert into hole 7e near bend 7c from inner side and then secure by washer 72b and hex nut 72c. In FIG. 2, an elastic means, such as spring 8a or rubber band 8b or 8c can use one end mount to bolt 71a, and another end mount to bolt 72a at inner side.

FIG. 4 shows details structure of spring mountable bolt 71a. Washer 71b push by hex nut 71c will stop at stopper n. Stopper k cannot passes groove 7d will push against longer portion 7c. The diameter and the length of shaft m will provide the space freedom for groove 7d of longer portion 7c to slide on. Circular groove j allow one end of spring 8a or rubber band 8b or 8c to slide right in. Some of the feature appeared on bolt 71a also appeared on bolts 73a and 72a.

Pedal tail 6c continues with U-shaped pedal cage 6a by a bend 6b, and face perpendicular to pedal shaft 4. Pedal tail 6c having one end fixed to an inner side corner of the pedal body and another end extend toward a rear direction. Pedal tail 6c having two holes: 6e and 6d. Hole 6e is higher than hole 6d, and hole 6e is farther away from the pedal body than hole 6d. The mid-points of holes 6e and 6d define a line having an acute angle to widthwise of pedal body. The acute angle provides the clearance for longer portion 7c to slide pass pedal shaft 4. FIGS. 3, 5, 6, 7, and 8 show L-shaped sheet metal (7a, 7b, 7c) is contracted by spring 8a. FIGS. 1, 9, and 10 show spring 8a and L-shaped sheet metal (7a, 7b, 7c) are extended.

Member 7a positioned at rear higher than the level plane of pedal body, and pointing outward. Biker can engage member 7a simply step on to the pedal and slide their foot backward, as shown in FIG. 1.

Cushion 9 is a piece of hard rubber providing a soft contact with the back of a shoe. Cushion 9 attached to the inside face of member 7a by inserting screws 91a and 92a into the holes 9a, 9b on cushion 9, then holes 7a1, 7a2 on member 7a, and then secure by washers 91b, 92b and hex nuts 91c, 92c on the other side.

In FIG. 2, the pedal body of this invention having a pedal stem 5, four branches 5a, 5b, 5c, 5d extend from pedal stem 5, and pedal cage (6a, 6b, 6c) attached to said four branches by securing screws 61, 62, 63, 64 into holes 6f, 6g, 6h, 6i on the pedal cage (6a, 6b, 6c) and then into the four holes on branches 5a, 5b, 5c, 5d.

Pedal stem 5 is the center portion of the pedal body, rotatably coupled to one end of pedal shaft 4. The other end of pedal shaft 4 adapted to be coupled to a bicycle cram arm at inner side.

A pedal tail can be made as an attachment to a pedal body, or as an attachment to a pedal cage. FIG. 11 is one of many possible examples. Figure 11 is a bent L-shaped sheet metal (6r, 6b, 6c) having holes 6s, 6t on member 6r, and holes 6d, 6e on member 6c. Member 6r can be attached to a rear portion of the pedal body by screws, washers, and hex nuts. Member 6b will be fixed to an inner side corner of the pedal body and member 6c will become the pedal tail. Holes 6d, 6e on member 6c will allow attachment to longer portion 7c of L-shaped sheet metal (7a, 7b, 7c) using bolts, washers and hex nuts.

The term “sheet metal” does not mean that the object have to be made from substance having metallic composition, the object could be made from any matter or composition of matters having the physical quality to handle the foot coupling task.

1. A bicycle pedal, comprising:
a) a pedal body;
b) a pedal shaft having a first end and a second end, wherein said first end rotatably coupled to a middle portion of said pedal body, wherein said second end adapted to be coupled to a bicycle crank arm at inner side of said pedal body;
c) wherein said pedal body comprising a tail strip, fix to an inner side portion of said pedal body and extend backward;
d) a L-shaped device comprising a shorter portion and a longer a portion, wherein said longer portion lengthwise slidably connect to said tail strip, wherein said longer portion cross widthwise of said pedal body and parallel to a plane sufficiently perpendicular to of said pedal shaft, wherein said shorter portion position behind said pedal body, extend from said longer portion at said inner side toward a direction opposite to said inner side; and
e) an elastic means having a first end and a second end, wherein said first end connect to a middle portion of said L-shaped device, wherein said second end connect to a portion of said pedal body to retract said L-shaped device after extend from said pedal body.

2. The bicycle pedal of claim 1, wherein said longer portion cross widthwise of said pedal body at an acute angle.

3. The bicycle pedal of claim 1, wherein said L-shaped device is a bend L-shaped sheet metal.

4. The bicycle pedal of claim 1, wherein said longer portion is an elongated strip, comprising a groove, oriented lengthwisely on said longer portion, wherein said groove allow bolt to pass through to establish the slidable connection with said pedal body.

5. The bicycle pedal of claim 1, wherein said elastic means comprising spring.

6. The bicycle pedal of claim 1, wherein said elastic means comprising rubber band.

7. The bicycle pedal of claim 1, wherein said shorter portion comprising a cushion attachment.

8. The bicycle pedal of claim 1, wherein said pedal body comprising a U-shaped pedal cage, wherein said U-shaped pedal cage comprising said tail strip continue with one end of said U-shaped pedal cage by an outward bend.

9. The bicycle pedal of claim 1, wherein said pedal body comprising a U-shaped pedal cage and said tail strip, wherein said tail strip is an attachment to said U-shaped pedal cage.

10. The bicycle pedal of claim 1, wherein said pedal body comprising said tail strip, wherein said tail strip is an attachment to said pedal body.
